(19) United States
(12) Patent Application Publication
(10) Pub. No.: US 2016/0210623 A1
(43) Pub. Date: Jul. 21, 2016

(54) PRE-AUTHORIZED DEVICE FOR SHOPPING EXPERIENCE

(71) Applicant: Ebay Inc., San Jose, CA (US)

(72) Inventor: Michael Voege, Santa Clara, CA (US)

(21) Appl. No.: 14/598,125

(22) Filed: Jan. 15, 2015

(51) Int. Cl. G06Q 20/40; G06Q 20/32; G06Q 20/12; G06Q 20/10

(52) U.S. Cl. CPC G06Q 20/40; G06Q 20/10; G06Q 20/3223; G06Q 20/12

(57) ABSTRACT

A system or a method may be provided to enable a user to set up a schedule with a payment provider that allows the user to specify details of a shopping schedule, shopping place, and/or device restrictions as desired. As such, the payment provider is able to determine whether a payment request made through a user device is at a location and/or a date/time anticipated by the user or expected by the payment provider, and to further determine whether the user device through which the user makes the payment request is pre-authorized based on various information from the payment request and restrictions/limitations associated with the user device.

### TECHNICAL FIELD

The present invention generally relates to mobile devices and more specifically to security measures of using mobile devices while shopping.

### BACKGROUND

In today's commerce, many payment transactions, such as retail purchases, payment transactions, and the like, are made electronically using mobile devices, such as a mobile phone, and/or a mobile computing device. Among the mobile devices, a wearable computing device, such as an intelligent bracelet, an intelligent watch, intelligent glasses, and so on, is promisingly convenient because of its highly mobile characteristic. However, such wearable device may be also prone to potential fraudulent activity. Therefore, there is a need for a system or a method that ensures a user is better able to use such mobile devices to make payment transactions without additional concerns about fraudulent activity.

### BRIEF DESCRIPTION OF THE FIGURES

FIG. 1 is a flowchart showing a process a user performs to set up a schedule account with a payment provider, according to one embodiment;

FIG. 2 is a flowchart showing a process a payment provider performs in processing a payment request from a user while going shopping, according to one embodiment;

FIG. 3 is a block diagram of an exemplary networked system suitable for implementing the process described herein, according to an embodiment; and

FIG. 4 is a block diagram of a computer system suitable for implementing one or more components in FIG. 3, according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a user having an account with a payment provider sets up a schedule that allows the user to specify details of a shopping schedule, shopping place, and/or device restrictions as desired. This enables the payment provider to determine whether a payment request made through a user device is at a location and/or a date/time anticipated by the user or expected by the payment provider, and to further determine whether the user device through which the user makes the payment request is pre-authorized based on various information from the payment request and restrictions/limitations associated with the user device. If the payment request is made at a location, at a time and through a device that are within parameters of the schedule or account limitations, the payment provider may more easily and securely process a payment request, such as without the user having to enter a PIN, password, biometric, or other authenticator. In addition, the user may restrict funds available at one or more different merchant locations and through one or more user devices to limit exposure to funds during the user's shopping experience.

In one embodiment, the user may set up the schedule by indicating, to the payment provider (such as by accessing the user's account with an app or site and entering specific information), dates/times of shopping, shopping destinations or merchant locations, devices the user is going to carry with, any restrictions at the one or more locations, and any restrictions for the one or more devices. The restrictions may include dollar amount, number of transactions, time of transaction, etc. In an alternative embodiment, a schedule may be generated by the payment provider to correspond to the user's account based on user's historic shopping behavior.

The schedule may be set up for a generic use and/or a specific shopping trip. More specifically, a user may set up a schedule for all future shopping authentication, another schedule for a one-time shopping trip, or yet another schedule for a specific period of time (e.g., a week, a month).

When the user arrives at a shopping destination specified in the user's schedule, the user may make a payment request as follows, according to one embodiment. The user logs into the user account with the payment provider, such as through a mobile app, web site, or mobile browser. The user may be asked to enter specific information, such as a user name, email address, password, PIN, or a biometric (e.g., fingerprint, voice, etc.). In one embodiment, the user may also be required to enter a number generated from a security token, such as a key fob, either physical or downloadable to the user device (e.g., a soft token generator). Once authenticated, the user may transmit information to the payment provider for the payment request. In other embodiments, this information may be transmitted without the user having to login with the payment provider, e.g., no requirement to enter a PIN, password, or biometric. In this case, the user can be checked in with the merchant through Bluetooth Low Energy (BLE) beacons or other means and the information communicated upon or after check-in. The information may include location information, payee information, transaction details, amount, and user device information (e.g., user device's identifier). The payment provider may determine the location of the user through various means, including through location services on the user device. The payment provider may determine the user device through various means, including through an identifier of the user device, such as a phone number. After the payment provider receives the information, the payment provider accesses the user's account to determine whether the user is scheduled, or expected, to shop (i.e., make a payment request) at the location using the user device and any restrictions or limitations on the account.

If the user is using the pre-authorized device at the scheduled location (and time if appropriate), the payment provider may apply any restrictions or limitations when processing the payment request. In an example, the payment request may be over the set limit at the current location. In another example, the payment request may be over the set limit for the user device that is used to make the payment request. If the location and time are correct according to the schedule and any and all restrictions are met, the payment provider may approve the payment request quickly without having the user provide additional information.

However, if the payment request cannot be approved initially for a variety of reasons (including not meeting restrictions/limitations of the schedule), the payment provider may request the user to resubmit information or provide additional information. For example, if the location is not the expected location or if the payment request is higher than the specified limit, the user may be asked one or more security questions or to provide one or more security measures to authenticate. If the payment provider is satisfied the user is the authorized user, the payment request may be approved.

As a result, the user is provided additional security when making payment requests while shopping, while at the same time not being inconvenienced when shopping with an expected device at an expected location.

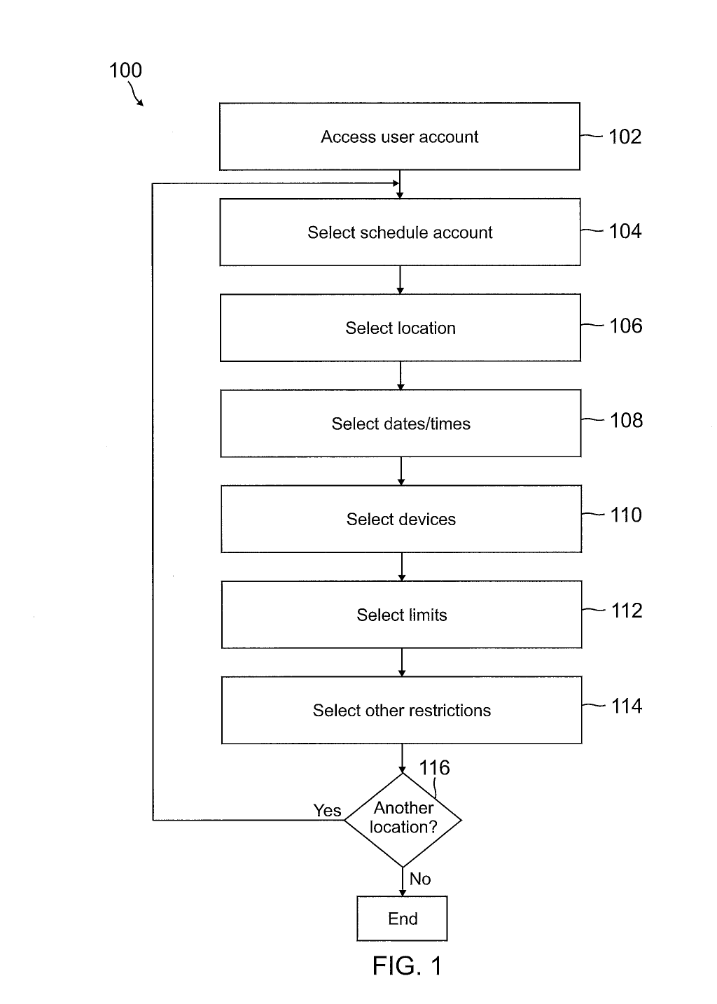

FIG. 1 is a flowchart showing a process 100 a user performs to set up a shopping or payment schedule with a payment provider, such as PayPal Inc. of San Jose, Calif., according to one embodiment. A user may wish to set up the schedule when the user is expecting to go shopping outside the user's business or home area and to use the services of the payment provider for payments. This may be done at the start of each date or any other time the user knows of likely shopping or payment request locations. At step 102, the user accesses a user account with the payment provider. The user may access the account through a user device, such as a smart phone, a computing tablet, a PC, or other computing device. For a smart phone, the user may access a mobile app, which makes a call to the payment provider and displays a login screen on the smart phone. For a PC, the user may enter the URL address of the payment provider and select a link on the payment provider site that opens a login page.

To access the user's account, the user may be asked to enter specific information, such as a user identifier and a login credential. These may include a user name, an email address, a phone number, a password, a PIN, or a biometric input, such as a fingerprint. The requested information is then communicated securely (encrypted) to the payment provider, such as through the user device or other means like a phone call or voice. If the user can be authenticated, the user is provided access to the user's account by the payment provider.

Once the user accesses the account, the user may see a home page of the account. On the home page may be an option to create, revise, view, or otherwise access a shopping or payment schedule. This may be in the form of a tab, link, button, or other user-selectable means. The user may select this option at step 104 to access the schedule option or feature. The user may then be directed to a new screen or a pop-up screen having schedule information and fields.

At step 106, the user may enter a merchant location or destination for shopping. For example, the user may be planning to shop in store A and will be visiting store B, store C, and store D. The user may enter the merchant location in any number of ways. For example, the user may enter a merchant name and/or corresponding information of a merchant location, such as address, telephone number, and/or branch name The user may also select desired merchant locations from a map, where the user may select a specific region and be presented with a more detailed map of that region, such as a map of southern California, then Los Angeles, then West Los Angeles. The user may also select merchants from a drop down menu that includes merchants the user has previously shopped at or been designated as favorites of the user. The user may be asked to confirm the selected merchant location or revise as needed.

At step 108, the user may select the dates/times the user plans on being at the selected merchant location(s). For the selected date, the user may enter a start and end time. The user may also select dates from a pop-up calendar. For example, the user may specify that the user intends to be in store A tomorrow (Feb. 2, 2015) from 9:00 am to 10:00 am. The user may be asked to confirm the dates and/or times for the merchant location. Once confirmed, the user may be presented with the selected merchant location(s) and dates/times. The merchant location(s) and date/time information may be communicated in other ways. For example, the user may provide the payment provider a copy of the user's shopping schedule, which the payment provider can scan or otherwise process to populate the user's schedule account.

At step 110, the user may select one or more devices that the user intends to use or to make a payment request through at the selected merchant location(s) or dates/times. In some embodiments, although the devices are limited to devices that are able to communicate wirelessly with the payment provider, other suitable devices that are capable of communicating with the payment provider directly or indirectly may also be used. Examples of devices the user may be selected include a mobile phone, an intelligent wearable device (e.g., Google Glass®, and Apple Watch®), a mobile computing device (iPad® from Apple®) and an intelligent attachable device (e.g., an intelligent lapel flower).

At step 112, the user may select one or more limits at the merchant location, for the dates/times, and/or the device(s). In an example, the user may not want or expect to spend more than $100 USD at store A. The user may also or alternatively provide limits according to a day or days. For example, the user may set a limit of $100 USD on Feb. 2, 2015, $150 USD on Feb. 3, 2015, and $50 USD on Feb. 4 and Feb. 5, 2015. Further, the user may provide limits for specific devices. For example, while the user shops at store C, the user tends to use his/her Google Glass® to make a payment more often than his/her mobile phone. Thus, the user may set a higher limit while using the Google Glass® to pay at store C than using the mobile phone. In another example, the user expects to shop using a smart watch at store D later in the day, even though the user typically shops (including at store D) using the user's smart phone. As such, the user may set or authorize shopping for the smart watch at store D for that day and/or time. The user may also designate or authorize specific devices beyond just a type of device in cases where the user has multiple smart phones, watches, glasses, or other mobile devices used for making payment requests.

At step 114, the user may set other restrictions as desired for the merchant location, dates/times, and/or devices. Other restrictions may include the number of transactions allowed each day, each period, or the merchant location. Restrictions may also include the type of merchant or purchase. For example, the user may not expect to make any purchases from street vendors. In that case, the user may specify that any payment requests from street vendors be denied. The user may also specify that no payment requests received for digital goods purchases should be approved.

In addition to restrictions, the user may specify additional information, such as contact information at each merchant location or date(s)/time(s). For example, the user may provide a cell phone number for each, some, or all merchant locations, which enables the user to receive an incentive from each corresponding merchant or merchant location.

Note that one or more of the steps described herein may be combined, performed in a different sequence, omitted, and/or combined as desired. Once the user has finished providing information for the first merchant location, a determination is made at step 116 whether the user wishes to add another merchant location. In an example, store A is a first merchant destination for a multi-merchant shopping trip. So, the user may want to add the other merchant location(s) to the schedule account. This may be done simply with a button or link from the user account page that the user can select to add another merchant location. If the user is finished adding merchant locations, the user may simply select a “finish” or other similar button or link to end the set-up process.

After entering each merchant location, including limits and/or restrictions, the user may be presented with information about the current schedule. Once finished, the user may be presented with the final schedule information. For example, the user may see a page or listing that shows the user intends to be in store A using his/her mobile phone and Google Glass® at Feb. 2, 2015 from 9 a.m. to 10 a.m., using his/her Google Glass® and Apple Watch® in store C at the same date from 10 a.m. to 11 a.m., and using only his/her mobile phone in store B from 3 p.m. to 5 p.m., with any associated limits or restrictions identified alongside each date/time, device or merchant location.

As described above, in an alternative embodiment, a schedule account may be created by the payment provider automatically according to user's shopping history and/or shopping behavior. The payment provider may store the user's shopping history and/or behavior as input data for a past period of time (e.g., a week or a month). Based on the stored input data, the payment provider may be further configured to recognize a pattern that is able to closely or seamlessly describe the user's past shopping behavior. For example, for a past week, a user has made a purchase at store Z using device Y recognized by the payment provider every day, and an amount for each purchase is between $ 10 USD to $ 20 USD. As such, a schedule may automatically be created, by the payment provider, for the user and/or the user's account, wherein the schedule specifies that the user is going to make a purchase at store Z using device Y, and the amount for each purchase should not exceed $ 20 USD. Moreover, the created schedule may be set up for an upcoming week or an upcoming month.

The user may access the account at any subsequent time to revise any of the information in the user's schedule, such as a change in merchant location, a change in dates/times, a change in devices, a change in limits, and/or a change in restrictions. In one embodiment, the user may only change one or more details while still in the user's home or business area. In other embodiments, the user may change details at any time prior to the date that the change is to take effect.

By setting up such a schedule account, the user may be provided with not only a higher security measure while shopping but also a better shopping experience. For example, the user may always be provided with the latest purchase incentives, through a user device, such as coupons, discount news, etc. The purchase incentives may be provided by the payment provider and/or by a merchant. As such, the user may avoid a hassle to collect physical coupons before shopping and/or carry the physical coupons while shopping. Moreover, through setting up a schedule account with the payment provider, the payment provider may be able to create a more seamlessly pattern to describe and/or predict the user's shopping behavior.

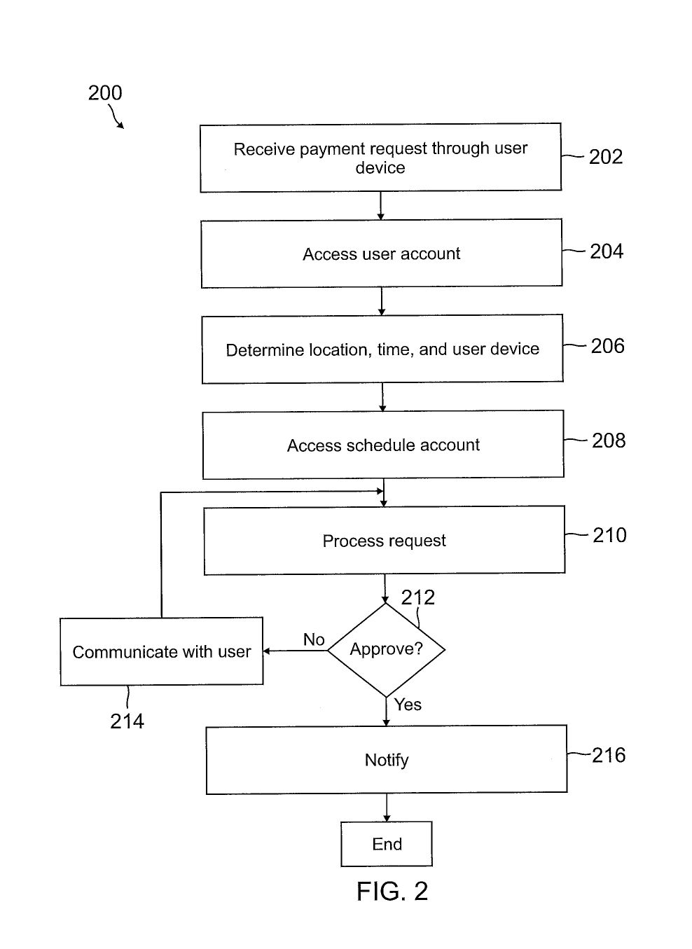

FIG. 2 is a flowchart showing a process 200 a payment provider performs in processing a payment request from a user while shopping according to one embodiment. At step 202, the user has left the user's home and has arrived at one of the merchant locations specified in the user's schedule account. Continuing with the above example, the user is in store A at 9:30 a.m. on Feb. 2, 2015 and desires to make a payment using his/her Google Glass® through the user's payment provider account. The user may access the user's account by entering requested credentials, such as a user name and password/PIN, through a mobile app or browser on the user device (e.g., his/her mobile phone). For additional security, the user may also be requested to enter a password generated from a security token, such as a fob, and/or from a soft token generator. More specifically, a security token may be implemented as a hardware device that is able to generate an one-time password; a soft token generator may be an in-app module that is configured to generate at least a password. The user may also forego the above and be checked in automatically at store A through store beacons or other device check-in means.

The payment provider receives a payment request, at step 202, from the user or a payee. The payment request may be from a user device, such as a smart phone, a payee device, such as a merchant POS, or a third party device. The payment request may include information about the user, such as a mobile phone number, a user name, user email address, or other user identifier if not previously provided during account access, the merchant, such as a merchant identifier, merchant name, location, time, merchant account number, etc., and the transaction, such as a total amount of the payment request, information about individual items in the purchase request, including price and description. Some of this information may be automatically conveyed through the user device (e.g., mobile phone number), payee device (e.g., merchant identifier and/or transaction information), or third party device.

Upon receiving the payment request, the payment provider accesses the user's account at step 204, using information about the user provided either at step 202 or during the login process. The payment provider may search one or more databases having account information to determine whether an account exists for the user. Assuming a valid account exists, the payment provider determines, at step 206, the user location or the merchant location where the payment request came from, the date/time when the payment request that is made, and/or through which user's device the request that is made. This determination may be accomplished in any number of ways. For example, the transaction information may include merchant location information. The merchant location information may also come from the device communicating the payment request, such as through an IP address from a PC of the payee/merchant or location service on a mobile device of the user. In another example, the location may be obtained through beacons.

At step 208, the payment provider access the user's schedule from the user's primary account. This allows the payment provider to determine information contained in the schedule account to aid in processing the payment request.

At step 210, the payment provider processes the payment request based on the information received and available through the user's account and schedule. The payment provider may first determine whether the payment request came from a selected merchant location through a selected device designated by the user. Even if the payment request originated from a merchant location identified in the user's schedule, the payment provider may still need to determine if the merchant location matches with the dates/times specified by the user. Continuing with the above example, the user/payment request may be determined to have come from store B at 9:30 a.m., which is in conflict with the selected merchant location and time of the user's schedule. This may prompt the payment provider to deny the payment request or require the user to provide additional information, such as a biometric (e.g., fingerprint) or password/PIN. However, if the payment request was sent at 4 p.m. on Feb. 2, 2015, the payment provider may proceed with authorization with further determining whether the payment request is made through the user's mobile phone (the only selected device in the user's schedule account).

In accordance with some embodiments, even though the payment request is made through only one user device at a merchant location, the payment provider may need to receive each individual identifier for the device that is selected, by the user, to be used at the merchant location. Continuing with the example in which the user specifies in the schedule account that between 9 a.m.˜10 a.m. on Feb. 2, 2015, a payment request is expected to be made through Google Glass® or the user' mobile phone at the store A, the payment provider may need both of the identifiers for the user's Google® Glass and mobile phone to be received by the payment provider. As such, a higher security measure to make a payment using a payment provider may be advantageously provided.

Processing may continue to determine whether any limits or restrictions are met or triggered. For example, the payment provider may determine whether there are any limits associated with the schedule, such as a maximum dollar amount or transaction number for the particular merchant location and/or date/time. If that maximum would be exceeded by the payment request, the payment provider may deny the request or require additional information or authentication from the user. However, if approving the payment request would not exceed any limits, the payment provider may process and approve the payment without further input from the user.

Thus, after processing, a determination is made, at step 212, whether the payment request can be approved. If, for whatever reason, the payment request cannot be approved by the payment provider, the payment provider may optionally communicate with the user at step 214. Communication may be for requesting additional information in an attempt to better authenticate the user or obtain approval from the user of the payment request. For example, the payment provider may call or text a phone number specified by the user on the schedule account or another phone number associated with the user's account. Alternatively or additionally, such authentication may be performed with a payment provider's app installed on a device that is with the user while making a purchase. The user may then be asked one or more security questions, such as mother's maiden name, mother's birthday, social security number, etc. The payment provider may also ask whether the pending payment request was actually made by the user. The communication may also be through email, text, or other means. Authentication or additional authentication may be required, such as providing biometric user data, entering a PIN or password, etc. Based on the information received by the payment provider, the payment provider may process the request again at step 210.

If the payment request can be approved, a confirmation notification may be sent by the payment provider at step 216. Notification may be to the user and/or the payee or merchant via a smart phone, PC, laptop, tablet, POS device, etc. The notification may be through a receipt, confirmation number, message or the like, and may be conveyed by text, email, voice, or other means (e.g., device vibration, device LED illumination/animation). Once the merchant confirms payment, either through the merchant, the payment provider, and/or the user, the merchant may release the purchase to the user.

As a result, the user may easily make a payment while shopping (even at locations or merchants the user does not shop at) because the payment provider knows the user is expected to be at a certain merchant location on certain dates/times, and moreover the payment provider knows which device is expected to be used for a payment request. This eliminates the need to either deny the payment request or contact the user for additional information, which may be needed because of payment provider receives a payment request from a merchant location not associated with or expected from the user. As a result, using the above, the user is provided with a better shopping experience without an interruption from a merchant and/or a payment provider. In addition to easier payment processing while shopping, the schedule may also provide the user additional security for making payments. This is due to the user being able to specify one or more devices to make payments and set limits and restrictions on payments made while shopping. Note that the schedule may be separate from the user's main payment provider account or part of the user's main payment provider account such that schedule is with the main account where the user can select a tab or link to toggle between the schedule and the main account.

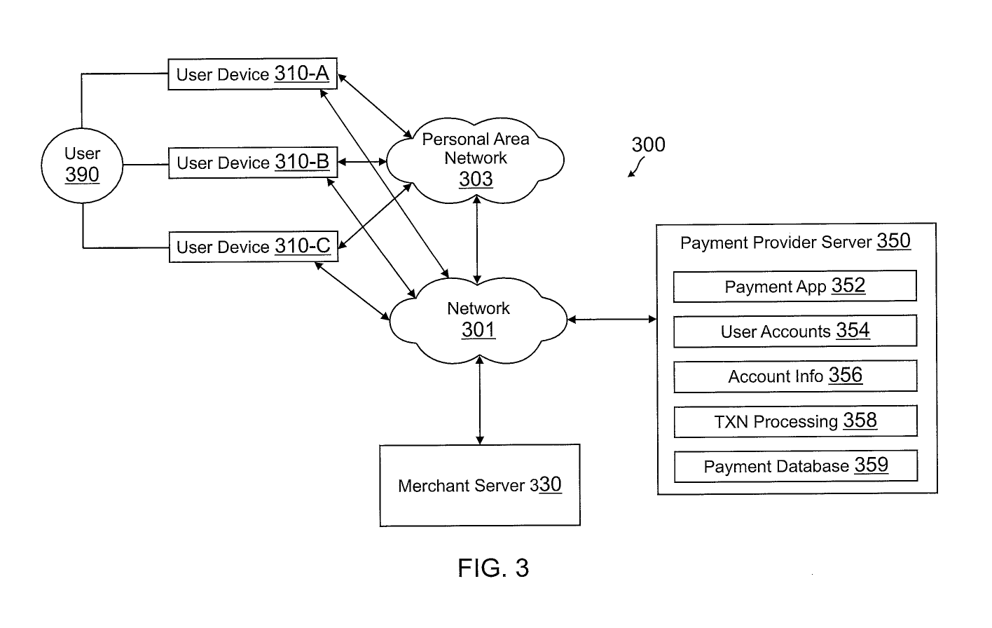

FIG. 3 illustrates an exemplary embodiment of a networked system 300 adapted for implementing a system and method for collaborating multiple user devices to increase a security measure while shopping at a merchant location. As shown, networked system 300 may comprise or implement a plurality of servers and/or software components that operate to perform various methodologies in accordance with the described embodiments. Exemplary servers may include, for example, stand-alone and enterprise-class servers operating a server operating system (OS) such as a MICROSOFT® OS, a UNIX® OS, a LINUX® OS, or other suitable server-based OS. It may be appreciated that the servers illustrated in FIG. 3 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Networked system 300 may include, among various devices, servers, databases and other elements, one or more client devices 310, such as a laptop, a mobile computing device, a tablet, a PC, a wearable device, a cellular telephone, smart phone, smart watch, fitness tracker band, biometric sensors, or other similar mobile devices that a user may carry on or about his or her person and access readily and/or any other computing device having computing and/or communications capabilities in accordance with various embodiments.

User devices 310 generally may provide one or more client programs, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), biometric monitoring and sensor applications (e.g. heart rate monitor, heat monitors, pedometers, finger print scanner and/or the like), contacts application, calendar application, electronic document application, database application, media application (e.g., music, video, television), location-based services (LBS) applications (e.g., GPS, mapping, directions, positioning systems, geolocation, point-of-interest, locator) that may utilize hardware components such as an antenna, and so forth. One or more of the client programs may display various graphical user interfaces (GUIs) to present information to and/or receive information from one or more users of user devices 310. In some embodiments, client programs may include one or more applications configured to conduct some or all of the functionalities and/or processes discussed below.

Network 301 may be implemented as a single network or a combination of multiple networks. For example, in various embodiments, network 301 may include the Internet or one or more intranets, landline networks, wireless networks, and/or other appropriate types of networks. As shown, user devices 310 may be communicatively coupled via one or more networks 301 to payment provider server 350 and/or merchant server 330.

In some embodiments, user devices 310 may be owned, managed, or operated by a single entity, such as a user 390, which may generally be carried and/or worn on or around the user. For example user devices 310 may include a smart watch, smart phone, fitness band, and/or the like. As additional things become computerized and fitted with wireless communications capabilities, such as clothing, jewelry, pace makers, medical band, anklets, bracelets, handcuffs, belts and other wearable objects, these things may also make up user devices 310. In some embodiments, user devices 310 may form a mesh network and/or a personal area network 303. Personal area network 303 may be created using short range wireless communicators such as Bluetooth®, Bluetooth® low energy, wireless infrared communications, wireless USB, Wi-Fi or other wireless technologies for exchanging data over short distances. In some embodiments, one or more of user devices 310 may act as a wireless hotspot for other client devices 310 to connect to one or more networks 301 and communicate with payment provider server 350 and/or merchant server 330.

Some and/or all of user devices 310 may contain applications and hardware to provide a variety of services, which may include, but are not limited to, biometric monitoring, location services, and/or the like. Biometric monitoring may be conducted by one or more of user devices 310 through a combination of one or more heartbeat monitors, electromyography (EMG) monitors, brainwave scanners, heat scanners, bioelectrical impedance (BIA) monitors, gait and/or motion detection using accelerometers and/or gyroscopes, pedometers, and/or the like.

Merchant server 330 may be maintained by a third-party such as a bank, merchant, and/or any other entity. Merchant server 330 may include ATM machines, payment card processors, servers, and/or the like. In various implementations, Merchant server 330 may be a server that may host applications associated with or employed by a third party. The services may include, but are not limited to, location services, social networking, payment processing, payment verification services, and/or the like.

Payment provider server 370 may be maintained, for example, by an online payment service provider which may provide payment between user 390 and the operator of merchant server 330. In this regard, payment provider server 350 includes one or more payment applications 352 which may be configured to interact with user device 301 and/or merchant server 330 over network 301 to facilitate the purchase of goods or services, communicate/display information, and send payments by user 390 of user device 301 and as discussed above.

Payment provider server 350 also maintains a plurality of user accounts 354, each of which may include account information 356 associated with individual users, including schedule account information for users. For example, account information 356 may include private financial information of users of devices such as account numbers, passwords, device identifiers, user names, phone numbers, credit card information, bank information, information about a user's schedule account, as discussed above, or other financial information which may be used to facilitate online transactions by user 390. Advantageously, payment application 352 may be configured to interact with merchant server 330 on behalf of user 390 during a transaction to track and manage payment requests and purchases made by users while going shopping.

A transaction processing application 358, which may be part of payment application 352 or separate, may be configured to receive information from a user device and/or merchant server 330 for processing and storage in a payment database 359. Transaction processing application 358 may include one or more applications to process information from user 390 for processing a payment request and payment while the user is shopping as described herein. As such, transaction processing application 358 may store details of a payment request from a user or merchant. Payment application 352 may be further configured to determine the existence of and to manage accounts for user 390, as well as create new accounts if necessary, such as the set-up, management, and use of a schedule account for the user.

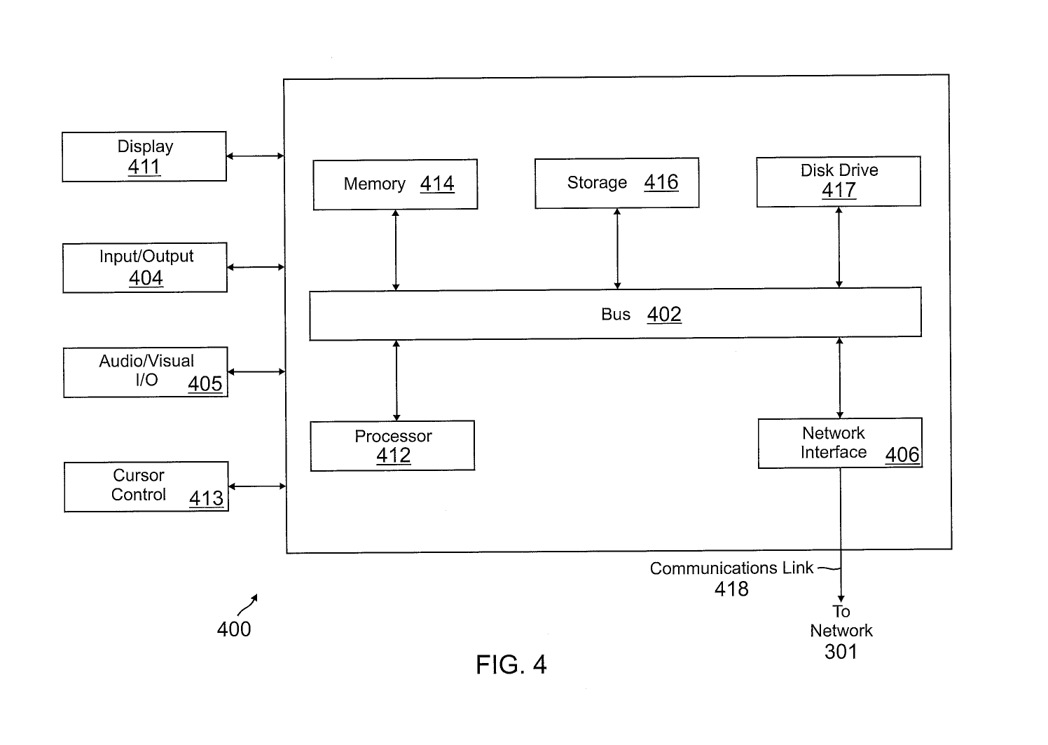

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory storage device storing account information with a payment provider, wherein the account information comprises schedule information; and
a processor in communication with the non-transitory storage device executing instructions to perform:
receiving a payment request, wherein the payment request is made through a user device;
determining a merchant location, a time of the payment request, and identifying information about the user device;
accessing a user account associated with the payment request;
determining schedule information for the user account; and
processing the payment request based, in part, on the schedule information.

2. The system of claim 1, wherein the schedule information comprises at least one merchant location, at least one date, and at least one user device for the user while going shopping.

3. The system of claim 2, wherein the schedule information further comprises payment request limits for each merchant location and each user device.

4. The system of claim 2, wherein the schedule information further comprises information about at least one predetermined merchant location for a user device.

5. The system of claim 1, wherein the user device is one of a wearable device, a mobile device, or an attachable device.

6. The system of claim 1, wherein the processing comprises determining whether the merchant location, the time, and the user device of the payment request is within parameters of the schedule information for the user account.

7. The system of claim 6, wherein the processor further performs communicating with a user of the user account if the payment request cannot be approved based on the schedule information.

8. The system of claim 1, wherein the processing further comprises determining whether the user device of the payment request is one of a plurality of pre-authorized user devices that are associated with the merchant location.

9. The system of claim 1, wherein the merchant location is determined through the user device when the payment request is made.

10. A method for performing a payment transaction using a user device, comprising:
receiving, by a processor of a payment provider, a payment request from a user through a user device;
determining, by the processor, a merchant location, a time of the payment request, and information about the user device;
accessing, by the processor, a user account associated with the payment request;
determining, by the processor, schedule information for the user account; and
processing the payment request based, in part, on the schedule information.

11. The method of claim 10, wherein the schedule information comprises at least one merchant location, at least one date, and at least one user device for the user while going shopping.

12. The method of claim 11, wherein the schedule information further comprises payment request limits for each merchant location and each user device.

13. The method of claim 10, wherein the processing comprises determining whether the merchant location, the time, and the user device of the payment request is within parameters of the schedule information for the user account.

14. The method of claim 13 further comprising if one of the merchant location, the time, and the user device of the payment request is not within parameters of the schedule information for the user account, communicating with a user of the user account.

15. A non-transitory machine-readable medium comprising a plurality of machine-readable instructions which when executed by one or more processors of a server are adapted to cause the server to perform a method comprising:
receiving a payment request through a user device;
determining a merchant location, a time of the payment request, and information about the user device;
accessing a user account associated with the payment request;
determining schedule information for the user account; and
processing the payment request based, in part, on the schedule information.

16. The non-transitory machine-readable medium of claim 15, wherein the schedule information comprises at least one merchant location, at least one date, and at least one user device for the user while going shopping.

17. The non-transitory machine-readable medium of claim 16, wherein the schedule information further comprises payment request limits for each merchant location and each user device.

18. The non-transitory machine-readable medium of claim 15, wherein the processing comprises determining whether the location, the time, and the user device of the payment request is within parameters of the schedule information for the user account.

19. The non-transitory machine-readable medium of claim 15, wherein the method further comprises if one of the merchant location, the time and the user device of the payment request is not within parameters of the schedule information for the user account, communicating with a user of the user account.

20. The non-transitory machine-readable medium of claim 15, wherein the merchant location is determined through a user device when the payment request is made.
